(19) United States
(12) Patent Application Publication
(10) Pub. No.: US 2006/0090301 A1
(43) Pub. Date: May 4, 2006

(54) Tool handle device for providing greater torque to a driven object

(76) Inventor: Chih-Ching Hsieh, Taichung Hsien (TW)

Correspondence Address: Chih-Ching HSIEH, 235 Chung - Ho, Box 8-24, Taipei, TW

(21) Appl. No.: 10/978,092

(22) Filed: Nov. 1, 2004

(51) Int. Cl. B25G 1/10

(52) U.S. Cl. 16/430

(57) ABSTRACT

A tool handle device comprises a handle portion; a driving portion protruding from one end of the handle portion for driving a screwing elements. A maximum diameter portion having a size which cause the user can hold the tool handle device by the thumb, the index finger and a part of the hand between the thumb and the index finger; and a diameter of the maximum diameter portion is a maximum one of the handle portion. A portion of the handle portion from the maximum diameter portion to one end portion connected to the driving portion has a length between one fourth and one tenth of the length of the handle portion. Another end of the handle portion has a retaining portion for retaining a hand holding the handle portion.

### FIELD OF THE INVENTION

The present invention relates to work tools, and particularly to a tool handle device, wherein the maximum diameter portion is formed at a portion contacting the holding portion of the hand so that a greater torque can be applied to the tool body. Thereby the user can drive a screwing means with less force. Thus, the working efficiency can be increased.

### BACKGROUND OF THE INVENTION

Referring to FIG. 4, it is illustrated that a prior art opener has a handle portion and a driving head. The driving head serves to drive a screwing means. The handle portion serves for being held by user's hand so that the hand can apply a force to the handle portion. In general, a diameter of the handle portion is larger than that of the driving head. Thereby according to principle of lever, the user can apply a greater torque to the opener so as to fasten or release the screw means.

However, the prior art opener is not a perfect one because if the opener is used to screw a tightening screwing means, it is often that the opener can not afford a sufficient force to the handle portion. This is because that the section of the handle portion held by the thumb and index finger of the hand has a reduced portion which has a diameter smaller than another section of the handle portion. However the thumb and index finger are strong ones of the hand. However since the section above mentioned has not a larger diameter and thus it can not provide a larger torque to the object to be screwed. Thereby the force can not effective provide to the object to be screwed. In the present invention, we will provide a novel design which can improve this prior art defect.

### SUMMARY OF THE INVENTION

Accordingly, the primary object of the present invention is to provide a tool handle device, wherein the maximum diameter portion 14 is formed at a portion contacting the holding portion of the hand so that a greater torque can be applied to the tool body. Thereby the user can drive a screwing means with less force. Thus, the working efficiency can be increased.

To achieve above objects, the present invention which provides a tool handle device comprises a handle portion; a driving portion protruding from one end of the handle portion for driving a screwing elements. A maximum diameter portion having a size which cause the user can hold the tool handle device by the thumb, the index finger and a part of the hand between the thumb and the index finger; and a diameter of the maximum diameter portion is a maximum one of the handle portion. A portion of the handle portion from the maximum diameter portion to one end portion connected to the driving portion has a length between one fourth and tenth fourth of the length of the handle portion. Another end of the handle portion has a retaining portion for retaining a hand holding the handle portion.

The various objects and advantages of the present invention will be more readily understood from the following detailed description when read in conjunction with the appended drawing.

### BRIEF DESCRIPTION OF THE DRAWINGS

FIG. 1 is a perspective view of the tool handle device of the present invention.

FIG. 2 is a schematic view of the tool handle device of the present invention.

FIG. 3 is a schematic view showing the application of the present invention.

FIG. 4 is a schematic view showing an application of one prior art opener.

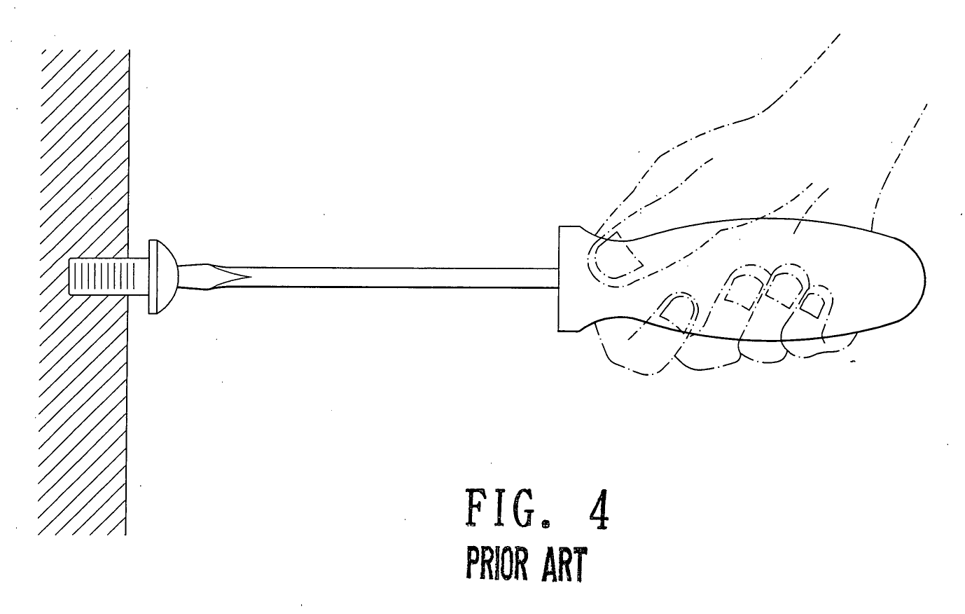

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

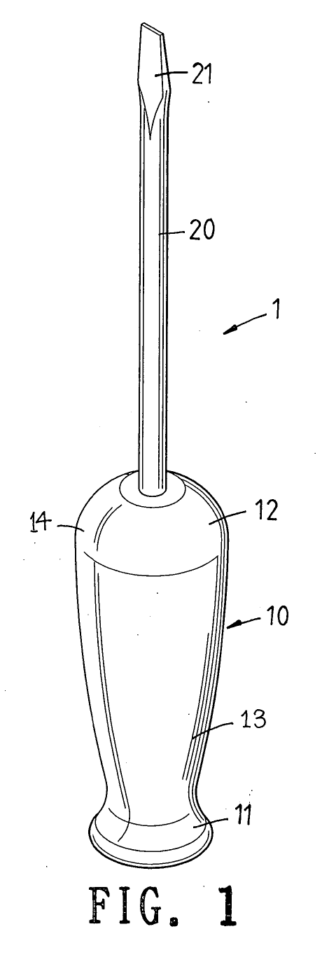

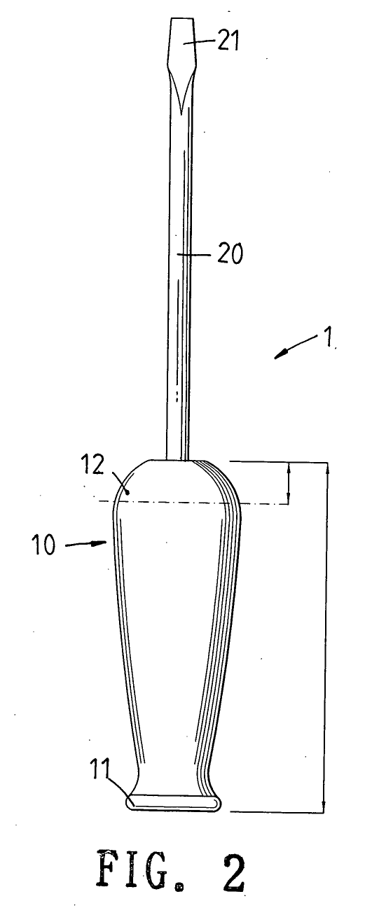

With reference to FIGS. 1 and 2, the tool handle device of the present invention is illustrated. The tool handle device may be for example, an opener. The tool handle device has the following elements.

A handle portion 10 is included.

A driving portion 20 protrudes from one end of the handle portion 10. A foremost end of the driving portion 20 far away from the handle portion 10 is a head 21 for driving a screwing element.

A retaining portion 11 is formed at another end of the handle portion 10. A diameter of the retaining portion 11 is greater than that of the handle portion 10. The retaining portion 11 has the effect of retaining the hand holding the tool handle device.

The handle portion 10 has a smooth cambered lateral side. The cambered lateral side of the handle portion 10 comprises the following portion.

A maximum diameter portion 14 has a size to cause that the user can hold the tool handle device by the thumb, the index finger and a part of the hand between the thumb and the index finger.

An upper reduced portion 12 is above the maximum diameter portion 14. The driving portion 20 protrudes from the upper reduced portion 12. The diameters of the upper reduced portion 12 are smaller than the diameter of the maximum diameter portion 14 and the diameters of the upper reduced portion 12 are reduced from a section near the maximum diameter portion 14 toward another section far away from the maximum diameter portion 14.

A lower reduced portion 13 is below the maximum diameter portion 14 and connected to the retaining portion 11. The diameters of the lower reduced portion 13 are smaller than that of the maximum diameter portion 14 and the diameters of the lower reduced portion 13 are reduced, from a section near the maximum diameter portion 14 toward another section far away from the maximum diameter portion 14.

A length of the upper reduced portion 12 is about one fourth to one tenth of the handle portion 10.

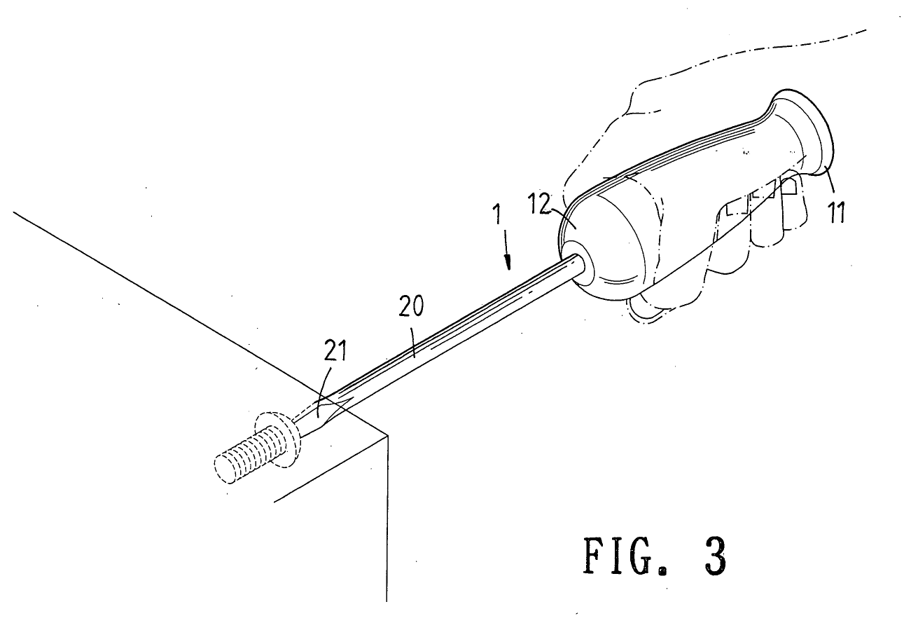

With reference to FIG. 3, when the user holds the handle portion 10 of the tool body 1. The user can hold the handle portion 10 by using the thumb, index finger and the portion between the thumb and the index finger. In driving a screw means, since the arm of force of the maximum diameter portion 14 is larger than other portions of the handle portion 10, it can apply a large torque to the tool body 1 to drive the screwing means.

Advantages of the present invention is that the maximum diameter portion 14 is formed at a portion contacting the holding portion of the hand so that a greater torque can be applied to the tool body 1. Thereby the user can drive a driving a screwing means with less force. Thus, the working efficiency can be increased.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A tool handle device comprising:
a handle portion;
a driving portion protruding from one end of the handle portion for driving a screwing element.
a maximum diameter portion having a size which cause the user can hold the tool handle device by using the thumb, the index finger and a part of the hand between the thumb and the index finger; and a diameter of the maximum diameter portion is a maximum one of the handle portion.

2. The tool handle device as claimed in claim 1, wherein a portion of the handle portion from the maximum diameter portion to one end portion connected to the driving portion has a length between one fourth and one tenth of the length of the handle portion.

3. The tool handle device as claimed in claim 1, wherein another end of the handle portion has a retaining portion for retaining a hand holding the handle portion.

4. A tool handle device comprising:
a handle portion;
a driving portion protruding from one end of the handle portion; a foremost end of the driving portion far away from the handle portion being a head for driving a screwing element;
a retaining portion being formed at one end of the handle portion; a diameter of the retaining portion being greater than that of the handle portion; the retaining portion having the effect of retaining the hand holding the tool handle device;
a handle portion having a smooth cambered lateral side; the cambered lateral side of the handle portion comprising;
a maximum diameter portion having a size to cause that one user can hold the tool handle device by the thumb, the index finger and a part of the hand between the thumb and the index finger;
an upper reduced portion located above the maximum diameter portion;
the driving portion protruding from the upper reduced portion; the diameters of the upper reduced portion being smaller than the diameter of the maximum diameter portion;
a lower reduced portion being below the maximum diameter portion and connected to the retaining portion; the diameters of the lower reduced portion being smaller than that of the maximum diameter portion.

5. The tool handle device as claimed in claim 4, wherein the diameters of the upper reduced portion are reduced from a section near the maximum diameter portion toward another section far away from the maximum diameter portion.

6. The tool handle device as claimed in claim 4, wherein the diameters of the lower reduced portion are reduced from a section near the maximum diameter portion toward another section far away from the maximum diameter portion.

7. The tool handle device as claimed in claim 4, wherein a portion of the handle portion from the maximum diameter portion to one end portion connected to the driving portion has a length between one fourth and one tenth of the length of the handle portion.
